(19) United States
(12) Patent Application Publication
(10) Pub. No.: US 2009/0116395 A1
(43) Pub. Date: May 7, 2009

(54) COMMUNICATION APPARATUS AND METHOD

(75) Inventors: Hiroyuki SASAKI, Kawasaki (JP); Masayuki Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/259,356

(22) Filed: Oct. 28, 2008

(30) Foreign Application Priority Data
Nov. 1, 2007 (JP) 2007-285500

(51) Int. Cl. H04L 12/26

(52) U.S. Cl. 370/245

(57) ABSTRACT

A communication apparatus includes a setting information storage section for storing band information set on each port, a continuity test signal transmitting section for receiving a continuity test request for testing a connection state of a connected network, and transmitting a continuity test signal to a destination port on the transmission path, a setting information obtaining section for obtaining the band information set on a port receiving the continuity test signal from the setting information storage section, a continuity response signal transmitting section for responding a continuity response signal added the band information obtained from the setting information obtaining section to the continuity test signal, to the port having transmitted the continuity test signal, and a setting information notification section for notifying the band information added to the continuity response signal to a node for managing the network.

### CROSS REFERENCE TO RELATED APPLICATIONS

This application is based upon and claims the benefit of priority from the prior Japanese Patent Application No. 2007-285500, filed on Nov. 1, 2007, the entire contents of which are incorporated herein by reference.

### BACKGROUND

The embodiments discussed herein are related to a communication apparatus having a plurality of ports for transmitting and receiving data based on a predetermined transmission path with an apparatus connecting thereto over a network, and a communication method therefor.

Hitherto, in a case where the alarm is given for alarming the occurrence of an apparatus failure in a wide area Ethernet (registered trademark), the apparatus or a PCB (printed circuit board) causing to the alarm is replaced to recover the service. On the other hand, in a case where a mistake in QoS (Quality of Service) setting such as band setting disconnects a communication, the “alarm due to an apparatus failure” is not given, and the manager of the apparatus does not notice about the failure. Therefore, the failed part is not identified until it is claimed by an end user.

With reference to FIG. 11, a failure due to a mistake in band setting according to a conventional technology is described. FIG. 11 is a diagram for describing a failure due to a mistake in band setting according to a conventional technology.

As shown in FIG. 11, a communication apparatus A is a communication apparatus that relays data, such as an L2 switch connecting to a wide area Ethernet and connects to multiple communication apparatus (such as communication apparatus B to F) in a manner allowing mutual data communication. Each of the communication apparatus has multiple ports (such as “Port A-1” and “Port A-2”), and a band is preset for each of the ports by a manager.

For example, it is assumed that 100 Mbps is set as the band settings for the “Port A-1” of the communication apparatus A, the “Port B-1” of the communication apparatus B and the “Port B-2” of the communication apparatus B, but 10 Mbps is set by mistake instead of 100 Mbps as the band setting for the “Port A-2” of the communication apparatus A. In this case, the network has a possibility that a packet may be lost if it is fed the packet of 10 Mbps or larger to the “Port A-2” of the communication apparatus A since the network provides a service of 100 Mbps, which disconnects the communication. As a result, when the continuity is tested with a Ping packet for continuity test by a manager, the Ping packet may or may not pass, and a long period of time may be required for locating a problem or failure in an apparatus and searching the cause.

Japanese Laid-open Patent Publication No. 2004-56728 discloses a switching node apparatus that dynamically establishes a path having an optimum band suitable for the type, characteristic or length of data to be transferred, transmits a packet from a transmitter node to a receiver node through a relay node and releases the path when the response is received from the receiver node after the end of the data transfer. On the other hand, the switching node apparatus is aware of the occurrence of a failure if no response is received from the receiver node.

However, the conventional technology has a problem that it is difficult to locate a failure in detail if apparatus failures such as a mistake in setting by a manager occurs for which the alarm indicating the occurrence of the failure is not given. For example, in a switching node apparatus according to the conventional technology, if the band setting has a mistake as shown in FIG. 11, the response from the receiver node after the end of the data transfer is delayed since the data transfer is performed with the mistaken band setting. In this case, even when the response can be received from the receiver node, it is difficult to locate the node having a failure.

### SUMMARY

The communication apparatus and method are made in order to solve the problems of the conventional technologies, and it is an object to provide a communication apparatus that allows locating a failure in detail in case where the failure occurs due to an unexpected apparatus failure or a setting mistake.

In order to solve the problems and achieve the object, according to an aspect of an embodiment, there is provided a communication apparatus having a setting information storage section for storing band information set on each port, a continuity test signal transmitting section for receiving a continuity test request for testing a connection state of a connected network, and transmitting a continuity test signal to a destination port on the transmission path, a setting information obtaining section for obtaining the band information set on a port receiving the continuity test signal from the setting information storage section, a continuity response signal transmitting section for responding a continuity response signal added the band information obtained from the setting information obtaining section to the continuity test signal, to the port having transmitted the continuity test signal, and a setting information notification section for notifying the band information added to the continuity response signal to a node for managing the network.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram showing a general outline and characteristics of a communication apparatus according to a first embodiment;

FIG. 2 is a configuration diagram showing a configuration of the communication apparatus according to the first embodiment;

FIG. 3 is a diagram showing an example of the format of a continuity response packet according to the first embodiment;

FIG. 4 is a flowchart showing setting information notification processing according to the first embodiment;

FIG. 5 is a diagram for describing processing by communication apparatus according to a second embodiment;

FIG. 6 is a flowchart illustrating setting information notification processing by the communication apparatus according to the second embodiment;

FIG. 7 is a diagram for describing setting information notification processing by multiple communication apparatus;

FIG. 8 is a diagram showing an example of the format of a continuity response packet using an LT function;

FIG. 9 is a diagram showing an example of the format of a continuity response packet when a VLAN tag is used;

FIG. 10 is a diagram showing a computer that executes a communication program; and

FIG. 11 is a diagram for describing a failure due to a mistake in band setting according to a conventional technology.

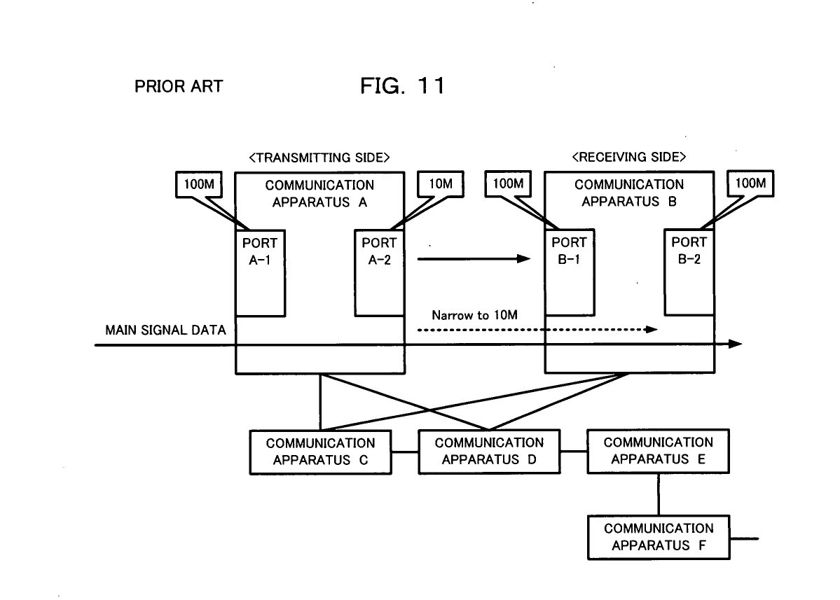

### DETAILED DESCRIPTION OF THE EMBODIMENTS

With reference to drawings, embodiments of the communication apparatus are described in detail below. The general outline and characteristics of the communication apparatus, and the configuration and the processing flows of the communication apparatus are described, and the advantages of the embodiments are finally described below.

### First Embodiment

(General Outline and Characteristics)

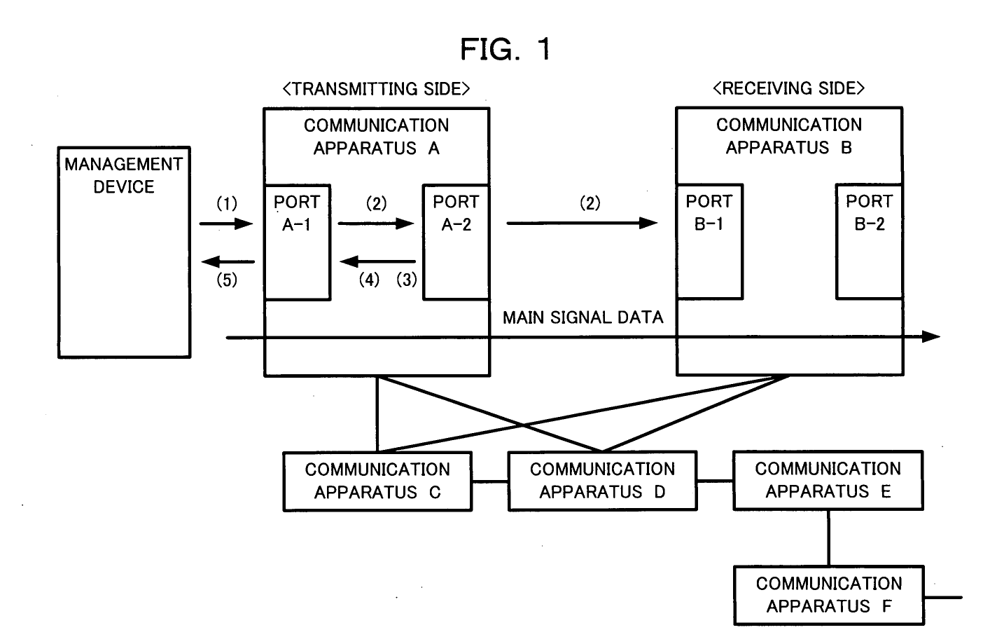

With reference to FIG. 1, a general outline and characteristics of a communication apparatus according to a first embodiment are described. FIG. 1 is a diagram showing a general outline and characteristics of the communication apparatus according to the first embodiment.

A communication apparatus A is a communication apparatus that relays data on an L2 switch connecting to a wide area Ethernet service and connects to communication apparatus B to F having similar functions to those of the communication apparatus A through multiple ports “Port A-1”, “Port A-2”, “Port B-1” and “Port B2” based on a transmission path predetermined by a manager for mutual data communication. The communication apparatus A connects to a management device that is a node managing the shown network.

For example, the predetermined transmission path is the transmission path from the “Port A-1” of the communication apparatus A to the “Port B-2” of the communication apparatus B through the “Port A-2” of the communication A and the “Port B-1” of the communication apparatus B. Then, the band settings of the ports of the communication apparatus A are “Port A-1: 100 Mbps” and “Port A-2: 10 Mbps”, and the band settings of the ports of the communication apparatus B are “Port B-1: 100 Mbps” and “Port B-2: 100 Mbps”, where the band setting of the “Port A2” is mistaken.

In this configuration, the general outline of the communication apparatus A is having multiple ports for transmitting and receiving data based on a predetermined transmission path with an apparatus connecting thereto over a network, and the communication apparatus A is particularly mainly characterized in that the communication apparatus A can detect a mistaken band setting, which may cause a failure excluding apparatus failures.

Describing the main characteristic more specifically, the communication apparatus A in response to the receipt of a continuity test request for testing the connection state of the network from the node that manages the network (refer to (1) in FIG. 1) receives data based on a predetermined transmission path and transmits a continuity test packet from the port having received the continuity test request to the port that transfers to the destination (refer to (2) in FIG. 1). Giving a more specific example, the communication apparatus A in response to the receipt by the “Port A-1” of the continuity test request for testing the connection state of the network from the management device that manages the network receives data based on the predetermined transmission path and transmits the continuity test packet from the “Port A-1” having received the continuity test request for testing the connection state of the network to the “Port A-2” that transfers it to the destination.

Then, the communication apparatus A obtains band information set for the port having received the continuity test packet from a predetermined storage section if the transmitted continuity test packet is received by the port that transfers (refer to (3) in FIG. 1). Describing more specifically, if the continuity test packet transmitted from the “Port A-1” is received by the “Port A-2” that transfers, the communication apparatus A obtains the band information “Port A-2: 10 Mbps” set for the “Port A-2” having received the continuity test packet from a predetermined storage section. The “Port A-2” having received the continuity test packet transfers the received continuity test packet to the “Port B-1” of the communication apparatus B.

After that, also the “Port B-1” of the communication apparatus B having received the transferred continuity test packet obtains the band information “Port B-1: 100 Mbps” set for the “Port B-1” from a predetermined storage section, like the “Port A-2”.

In this way, the processing above is performed at the port that receives and transfers the continuity test packet.

Next, the communication apparatus A generates a continuity response packet including the obtained band information added to the continuity test packet and responds it to the port having transmitted the continuity test packet (refer to (4) in FIG. 1). Describing more specifically, the communication apparatus A generates a continuity response packet including the band information “Port A-2: 10 Mbps” obtained from the “Port A-2” added to the continuity test packet and transmits the continuity response packet to the “Port A-1” having transmitted the continuity test packet.

The “Port B-1” of the communication apparatus B having received the continuity test packet generates a continuity response packet including the band information “Port B-1: 100 Mbps” added to the continuity test packet and transmits the continuity response packet to the “Port A-1” having transmitted the continuity test packet.

In this way, the processing above is performed at the port having received a continuity test packet.

After that, if the responded continuity response packet is received by the port having transmitted the continuity test packet, the communication apparatus A obtains the band information added to the continuity response packet and notifies it to the node that manages the network (refer to (5) in FIG. 1). Describing more specifically, if the continuity response packet including the band information “Port A-2: 10 Mbps” is received by the “Port A-1” having transmitted the continuity test packet, the communication apparatus A obtains the band information “Port A-2: 10 Mbps” added to the continuity response packet and notifies it to the management device that manages the network. If the continuity response packet including the band information “Port B-1: 100 Mbps” is transmitted by the “Port B-1” of the communication apparatus B and is received by the “Port A-1”, the communication apparatus A obtains the band information added to the continuity response packet and notifies it to the management device that manages the network.

In this way, the processing above is performed at the port having received the continuity response packet. Notably, the management device having received the notification of the band information by the communication apparatus A determines setting information for each port from the notified band information and locates a failure due to a mistaken setting.

For that reason, if the communication apparatus A according to the first embodiment has multiple ports for transmitting and receiving data based on a predetermined transmission path with an apparatus connecting thereto over a network, the continuity response packet including the band information for a port can be obtained. As a result, a mistaken band setting, which may cause a failure excluding apparatus failures, can be detected as in the main characteristic.

### Configuration of Communication Apparatus According to First Embodiment

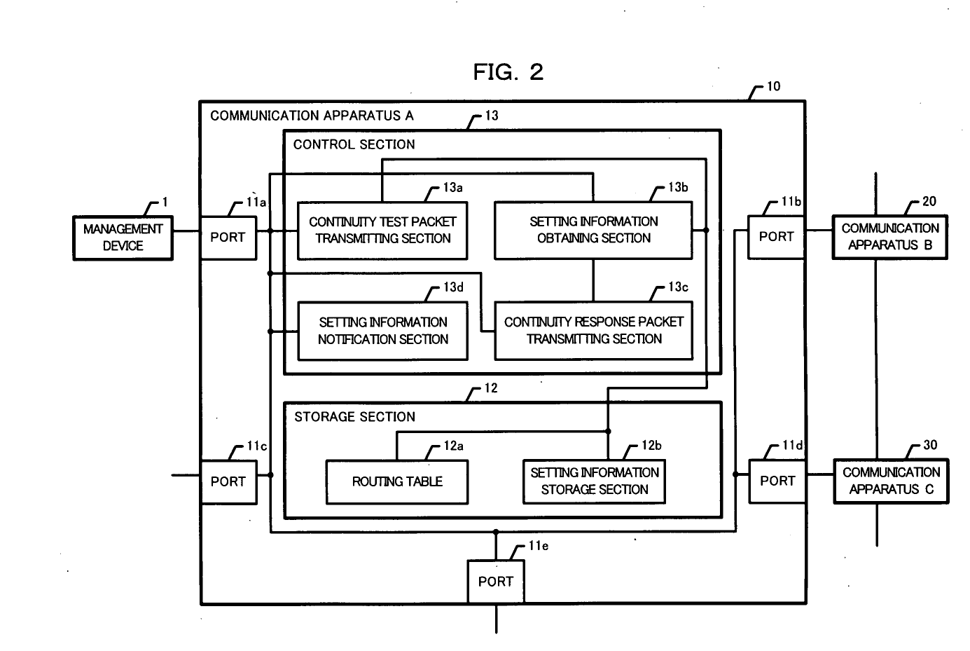

Next, with reference to FIG. 2, a configuration of the communication apparatus according to the first embodiment is described. FIG. 2 is a configuration diagram showing a configuration of the communication apparatus according to the first embodiment. As shown in FIG. 2, a communication apparatus A10 includes ports 11a to 11e, a storage section 12 and a control section 13. The communication apparatus A10, a communication apparatus B20 and a communication apparatus C30 have similar functions, and the communication apparatus A10 is described as an example. The communication apparatus A10 connects to the communication apparatus B20, the communication apparatus C30 and a management device 1, which is a node that manages the network, in a manner allowing mutual data communication. It is assumed that the band setting of the ports excluding the port 11b is 100 Mbps while the band setting of the port 11b is 10 Mbps, where the port 11b has the mistaken setting. In this network, the path from the port 11a of the communication apparatus A10 to the communication apparatus B20 through the port 11b is the predetermined path.

The ports 11a to 11e are terminals that input/output data to be transmitted and received over the network. The port 11a to port 11e transmit and receive data to the management device 1, the communication apparatus B20 or the communication apparatus C30, for example, based on the predetermined transmission path. While five ports of the ports 11a to 11e are shown in FIG. 2, the communication apparatus A10 may have one or multiple ports.

The storage section 12 includes a routing table 12a and a setting information storage section 12b and stores data required for processing by the control section 13 and/or processing results by the control section 13.

The routing table 12a stores data transmission path information over a network connecting to the communication apparatus A10. For example, the routing table 12a stores data transmission path information describing that the communication apparatus B20 connects to the port 11B, and the communication apparatus C30 connects to the communication apparatus B20 and, if a continuity test request is received from the management device 1, a continuity test packet is transmitted from the port 11a to the communication apparatus B20 through the port 11b.

The setting information storage section 12b may store band information set for multiple ports. For example, the setting information storage section 12b may store band information set for the ports 11a to 11e as in “Port 11a: 100 Mbps”, “Port 11b: 10 Mbps” and “Port 11c: 100 Mbps”.

The control section 13 has an internal memory for storing a control program, a program defining a routine and required data and includes a continuity test packet transmitting section 13a, a setting information obtaining section 13b, a continuity response packet transmitting section 13c and a setting information notification section 13d and performs various kinds of processing by using them.

The continuity test packet transmitting section 13a in response to the receipt of a continuity test request for checking the connection state of a network from the node that manages the network receives data based on the predetermined transmission path and transmits a continuity test packet that checks the inter-apparatus (or inter-port) continuity state from the port having received the continuity test request to the port that transfers to a destination.

Giving an example more specifically, if a continuity test request for checking the connection state of the network from the management device 1 that manages the network is received by the port 11a, the continuity test packet transmitting section 13a receives data based on data transmission information stored in the routing table 12a and transmits a continuity test packet from the port 11a having received the continuity test request to the port 11b that transfers to a destination.

If the continuity test packet transmitted by the continuity test packet transmitting section 13a is received by the port that transfers, the setting information obtaining section 13b obtains the band information set for the port having received the continuity test packet from the setting information storage section 12b.

Describing more specifically, if the continuity test packet transmitted from the port 11a is received by the port 11b that transfers, the setting information obtaining section 13b obtains the band information “Port 11b: 10 Mbps” set for the port 11b having received the continuity test packet from the setting information storage section 12b. Then, if the continuity test packet transmitted from the port 11a is received by the port 11b, the setting information obtaining section 13b transfers the received continuity test packet based on the data transmission path information stored in the routing table 12a to the communication apparatus B20. Notably, the communication apparatus B20 having received the transfer of the continuity test packet also obtains the band information set for the ports from the setting information storage section of the communication apparatus B20.

The continuity response packet transmitting section 13c generates a continuity response packet including the band information obtained by the setting information obtaining section 13b added to the continuity test packet and responds it to the port having transmitted the continuity test packet.

Describing more specifically, the continuity response packet transmitting section 13c generates a continuity response packet including the band information “Port 11b: 10 Mbps” obtained by the setting information obtaining section 13b added to the continuity test packet. Then, the continuity response packet transmitting section 13c transmits the continuity response packet to the port 11a having transmitted the continuity test packet. The communication apparatus B20 having received the continuity test packet also generates a continuity response packet including the obtained band information set for the ports added to the continuity test packet and transmits the continuity response packet to the port 11a having transmitted the continuity test packet. On the format of the continuity test packet according to the first embodiment, the band information is described within the ICMP (Internet Control Message Protocol) section area of an ICMP frame.

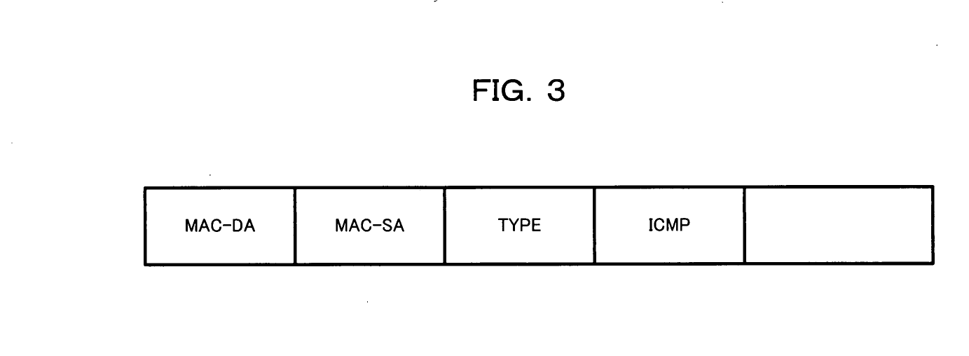

FIG. 3 is a diagram showing an example of the format of the continuity repose packet according to the first embodiment. MAC-DA and MAC-SA are MAC (Media Access Control) address sections, MAC-DA is a destination address and MAC-SA is a source address. Type is an identifier of the type of the frame. The ICMP section is data for QoS setting, speed setting and Duplex setting.

If the continuity response packet responded by the continuity response packet transmitting section 13c is received by the port having transmitted the continuity test packet, the setting information notification section 13d obtains the band information added to the continuity response packet and notifies it to the node that manages the network.

Describing the example more specifically, if the continuity response packet including the band information “Port 11b: 10 Mbps” is received by the port 11a having transmitted the continuity test packet, the setting information notification section 13d obtains the band information “Port 11b: 10 Mbps” added to the continuity response packet. Then, the setting information notification section 13d notifies the obtained band information to the management device 1 that manages the network. If the continuity response packet including the band information for the ports of the communication apparatus B20 is received by the port 11a, the setting information notification section 13d also obtains the band information added to the continuity response packet and notifies it to the management device 1 that manages the network. After that, the management device 1 having received the notification of the band information from the communication apparatus A10 determines the setting information for the ports based on the notified band information and locates a failure due to the mistaken setting.

### Processing by the Communication Apparatus According to First Embodiment

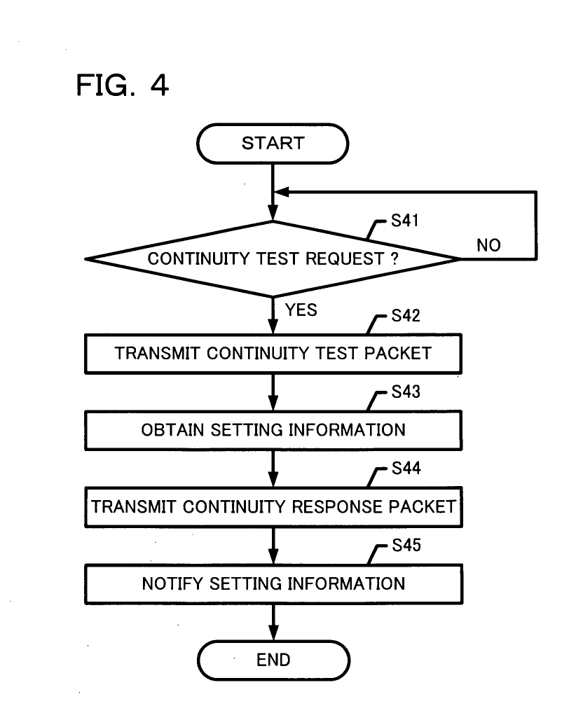

Next, with reference to FIG. 4, setting information notification processing by the communication apparatus A10 according to the first embodiment is described. FIG. 4 is a flowchart showing setting information notification processing by the communication apparatus A10 according to the first embodiment.

As shown in FIG. 4, in response to the receipt of a continuity test request for checking the connection state of the network from the node that manages the network (Yes in step S41), the communication apparatus A10 receives data based on the predetermined transmission path and transmits a continuity test packet from the port having received the continuity test request to the port that transfers to a destination (step S42). Giving an example more specifically, if the continuity test request from the management device 1 is received by the port 11a, the continuity test packet transmitting section 13a transmits a continuity test packet from the port 11a having received the continuity test request to the port 11b.

Then, if the transmitted continuity test packet is received by the port that transfers, the communication apparatus A10 obtains the band information set for the port having received the continuity test packet from the setting information storage section 12b (step S43).

Giving an example more specifically, if the continuity test packet transmitted from the port 11a is received by the port 11b, the setting information obtaining section 13b obtains the band information “Port 11b: 10 Mbps” set for the port 11b from the setting information storage section 12b.

Next, the communication apparatus A10 generates a continuity response packet including the obtained band information added to the continuity test packet and responds it to the port having transmitted the continuity test packet (step S44). Giving an example more specifically in the example above, the continuity response packet transmitting section 13c generates a continuity response packet including the band information “Port 11b: 10 Mbps” obtained by the setting information obtaining section 13b added to the continuity test packet. Then, the continuity response packet transmitting section 13c transmits a continuity response packet to the port 11a having transmitted the continuity test packet.

After that, if the responded continuity response packet is received by the port having transmitted the continuity test packet, the communication apparatus A10 obtains the band information added to the continuity response packet and notifies it to the node that manages the network (step S45).

Describing more specifically, if the continuity response packet including the band information “Port 11b: 10 Mbps” is received by the port 11a, the setting information notification section 13d obtains the band information “Port 11b: 10 Mbps” added to the continuity response packet. Then, the setting information notification section 13d notifies the obtained band information to the management device 1. After that, the management device 1 having received he notification of the band information from the communication apparatus A10 determines the setting information for the ports based on the notified band information and locates a failure due to the mistaken setting.

### Advantages of First Embodiment

The first embodiment allows followings. The communication apparatus A10 stores band information set for multiple ports in a storage section. If a continuity test request for checking the connection state of a network is received from a node that manages the network, the communication apparatus A10 receives data based on a predetermined transmission path and transmits a continuity test packet from the port having received the continuity test request to the port that transfers to a destination. If the transmitted continuity test packet is received by the port that transfers, the communication apparatus A10 obtains the band information set for the port having received the continuity test packet from the storage section, generates a continuity response packet including the obtained band information added to the continuity test packet and responds it to the port having transmitted the continuity test packet. If the responded continuity response packet is received by the port having transmitted the continuity test packet, the communication apparatus A10 obtains the band information added to the continuity response packet and notifies it to the node that manages the network. Therefore, a mistaken band setting, for example, which may cause a failure excluding apparatus failures, can be detected.

For example, if a continuity test request is received from the management device 1 that manages the network based on the predetermined transmission path from the port 11a (with a band setting of 10 Mbps) of the communication apparatus A10 to the communication apparatus B20 (with a band setting of 100 Mbps) through the port 11b (with a band setting of 10 Mbps), the communication apparatus A10 receives data based on the data transmission path information stored in the routing table 12a and transmits a continuity test packet from the port 11a having received the continuity test request to the port 11b that transfers to a destination. Then, if the transmitted continuity test packet is received by the port 11b that transfers, the communication apparatus A10 obtains the band information (which is the band setting: 10 Mbps) set for the port 11b having received the continuity test packet from the setting information storage section 12b that stores band information set for each port. Then, the communication apparatus A10 generates a continuity response packet including the obtained band information (band setting: 10 Mbps) added to the continuity test packet and responds it to the port 11a having transmitted the continuity test packet. After that, if the continuity response packet responded by the port 11b is received by the port 11a having transmitted the continuity test packet, the communication apparatus A10 obtains the band information (band setting: 10 Mbps) added to the continuity response packet and notifies it to the management device 1 that manages the network. The management device 1 having received the notification of the band information from the communication apparatus A10 locates a failure by determining that the band information (band setting: 10 Mbps) of the port 11b is a mistaken setting. As a result, the communication apparatus A10 can detect a mistaken band setting, which may cause a failure excluding apparatus failures.

### Second Embodiment

The case has been described in which a management device is used as a device that manages a network to detect a mistaken band setting, which may cause a failure excluding apparatus failures, according to the first embodiment. According to a second embodiment, an NMS (Network Management System) is used as a device that manages a network to detect a mistaken band setting, which may cause a failure excluding apparatus failures.

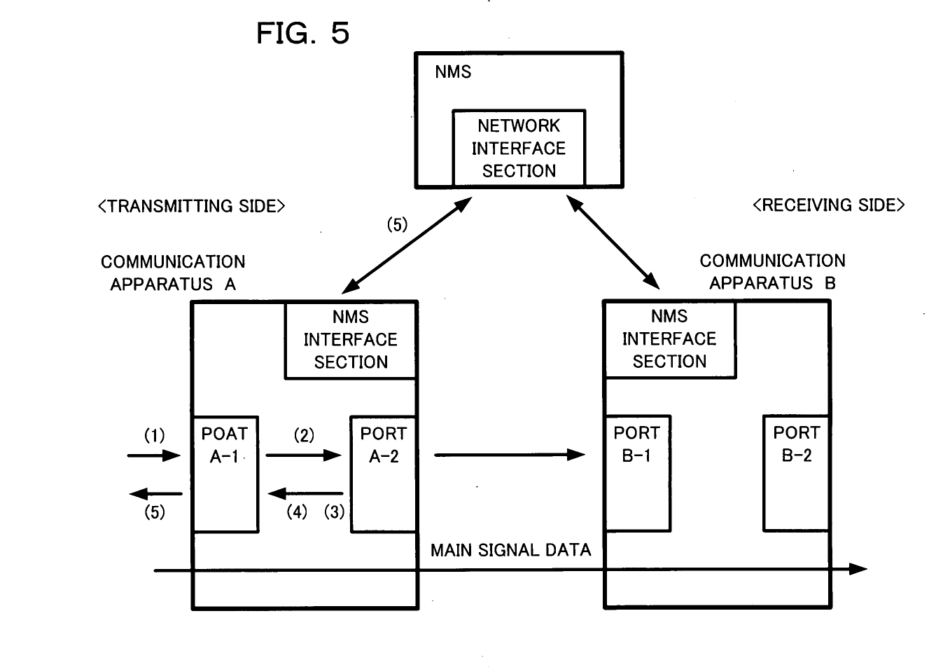

With reference to FIG. 5, processing by a communication apparatus A10 according to the second embodiment is described below. FIG. 5 is a diagram for describing processing by the communication apparatus A10 according to the second embodiment. Since the configuration and functions of the communication apparatus A10 according to the second embodiment are the same as those of the first embodiment, the description is omitted herein. Since processing in the communication apparatus B20 is similarly performed to that of the communication apparatus A10, the description also is omitted herein.

### Processing by Communication Apparatus According to Second Embodiment

An NMS that grasps information on multiple ports, centrally manages the network connects to the communication apparatus A10, communication apparatus B20, communication apparatus C30 and a communication apparatus, not shown, and collectively sets setting information for the ports of the communication apparatus. In this configuration, as shown in FIG. 5, if an event occurs in the network (refer to (1) in FIG. 5), the communication apparatus A10 receives data based on a predetermined transmission path and transmits a continuity test packet from the port having the event to the port that transfers to a destination (refer to (2) in FIG. 5).

Giving an example more specifically, if an event such as a trap having a function of notifying an event occurring over a network and a syslog having a function of displaying or recording an event occurring in a system and information thereon in a message form occurs at the “Port A-1” of the communication apparatus A10, the communication apparatus A10 receives the data based on the predetermined transmission path and transmits the continuity test packet from the “Port A-1” having the event to the “Port A-2” that transfers to a destination.

Also in a case where an event occurs in the communication apparatus B20, a continuity test packet is transmitted from the “Port B-1” having the event to the “Port B-2”.

Then, if the transmitted continuity test packet is received by the port that transfers, the communication apparatus A10 obtains the band information set for the port having received the continuity test packet from a predetermined storage section (refer to (3) in FIG. 5).

Describing more specifically, if the continuity test packet transmitted from the “Port A-1” is received by the “Port A-2” that transfers, the communication apparatus A10 obtains the band information “Port A-2: 10 Mbps” set for the “Port A-2” having received the continuity test packet from the setting information storage section 12b.

Next, the communication apparatus A10 generates a continuity response packet including the obtained band information added to the continuity test packet and responds it to the port having transmitted the continuity test packet (refer to (4) in FIG. 5). Describing more specifically with reference to the example, the communication apparatus A10 generates a continuity response packet including the band information “Port A-2: 10 Mbps” obtained by the “Port A-2” added to the continuity test packet and transmits the continuity response packet to the “Port A-1” having transmitted the continuity test packet.

After that, if the responded continuity response packet is received by the port having transmitted the continuity test packet, the communication apparatus A10 obtains the band information added to the continuity response packet and notifies it to the NMS that manages the network (refer to (5) in FIG. 5).

Describing more specifically, if the continuity response packet including the band information “Port A-2: 10 Mbps” is received by the “Port A-1” having transmitted the continuity test packet, the communication apparatus A10 obtains the band information “Port A-2: 10 Mbps” added to the continuity response packet and notifies it to the NMS that manages the network through an NMS interface section of the communication apparatus A10. The NMS having received the notification of the band information from the communication apparatus A10 determines the setting information for the ports from the notified band information, locates a failure due to the mistaken setting and collectively sets the located failure position.

In this way, the communication apparatus A10 according to the second embodiment has multiple ports for exchanging data based on a predetermined transmission path with an apparatus connecting thereto over a network. In connecting to an NMS that grasps the information on the multiple ports and centrally manages the network, the communication apparatus A10 can collectively set the band information from the NMS to the communication apparatus. As a result, the operation errors such as a mistaken setting of band information can be reduced.

### Processing Flow by Communication Apparatus According to Second Embodiment

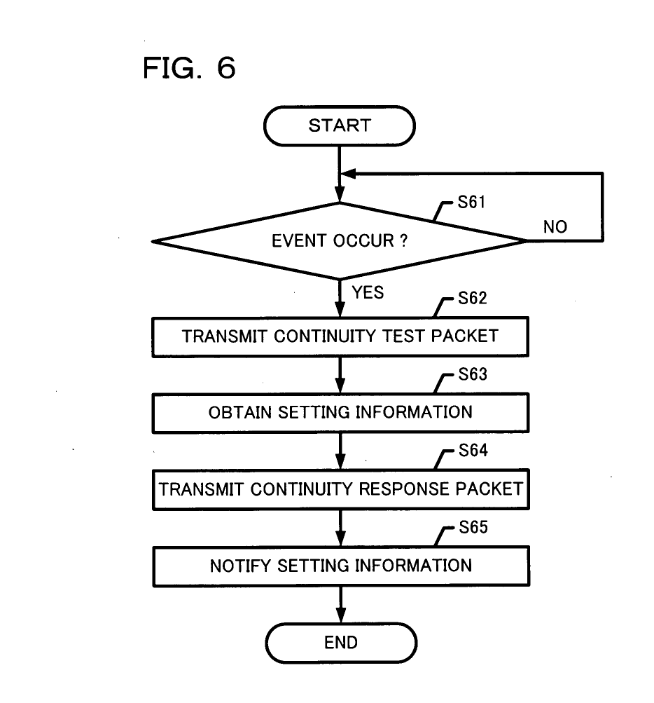

Next, with reference to FIG. 6, setting information notification processing by the communication apparatus A10 according to the second embodiment is described. FIG. 6 is a flowchart illustrating setting information notification processing by the communication apparatus A10 according to the second embodiment.

As shown in FIG. 6, if an event occurs in a network (Yes in step S61), the communication apparatus A10 receives the data based on a predetermined transmission path and transmits a continuity test packet from the port having the event to the port that transfers to a destination (step S62).

Giving a more specific example, if the port 11a of the communication A10 has an event such as a trap having a function of notifying an event occurring over a network or a syslog having a function of displaying or recording an event occurring in a system and information in a message form, the continuity test packet transmitting section 13a transmits a continuity test packet from the port 11a having the event to the port 11b.

Then, if the transmitted continuity test packet is received by the port that transfers, the communication apparatus A10 obtains the band information set for the port having received the continuity test packet from the setting information storage section 12b (step S63).

Giving an example more specifically, if the continuity test packet transmitted from the port 11a is received by the port 11b, the setting information obtaining section 13b obtains the band information “Port 11b: 10 Mbps” set for the port 11b from the setting information storage section 12b.

Next, the communication apparatus A10 generates a continuity response packet including the obtained band information added to the continuity test packet and responds it to the port having transmitted the continuity test packet (step S64).

Giving an example more specifically, the continuity response packet transmitting section 13c generates a continuity response packet including the band information “Port 11b: 10 Mbps” obtained from the setting information obtaining section 13b added to the continuity test packet. Then, the continuity response packet transmitting section 13c transmits the continuity response packet to the port 11a having transmitted the continuity test packet.

After that, if the responded continuity response packet is received by the port having transmitted the continuity test packet, the communication apparatus A10 obtains the band information added to the continuity response packet and notifies it to the NMS that manages the network (step S65).

Describing more specifically, if the continuity response packet including the band information “Port 11b: 10 Mbps” is received by the port 11a, the setting information notification section 13d obtains the band information “Port 11b: 10 Mbps” added to the continuity response packet. Then, the setting information notification section 13d notifies the obtained band information to the NMS through the NMS interface section. After that, the NMS having received the notification of the band information from the communication apparatus A10 determines the setting information for the port based on the notified band information, locates the failures due to the mistaken setting and collectively sets the located failure.

### Advantages of Second Embodiment

In this way, the second embodiment allows following. If an event occurs in a network, the communication apparatus A10 receives data based on a predetermined transmission path and transmits a continuity test packet from the port having the event to the port that transfers to a destination. If the transmitted continuity test packet is received by the port that transfers, the communication apparatus A10 obtains the band information set for the port having received the continuity test packet from a storage section, generates a continuity response packet including the obtained band information added to the continuity test packet and responds it to the port having transmitted the continuity response packet. If the responded continuity response packet is received by the port having transmitted the continuity test packet, the communication apparatus A10 obtains the band information added to the continuity response packet and notifies it to the NMS that manages the network. Therefore, the setting information can be checked quickly, and the operation errors such as the mistaken setting on band information can be reduced.

For example, if an event occurs in the port 11a of the communication apparatus A10, the communication apparatus A10 transmits a continuity test packet from the port 11a having the event to the port 11b. Then, if the continuity test packet transmitted from the port 11a is received by the port 11b, the communication apparatus A10 obtains the band information “Port 11b: 10 Mbps” set for the port 11b from the setting information storage section 12b. Then, the communication apparatus A10 generates a continuity response packet including the obtained band information “Port 11b: 10 Mbps” added to the continuity test packet and transmits the generated continuity response packet to the port 11a having transmitted the continuity test packet. Then, if the continuity response packet is received by the port 11a, the communication apparatus A10 obtains the band information “Port 11b: 10 Mbps” added to the continuity response packet. Then, the communication apparatus A10 notifies the obtained band information to the NMS through the NMS interface section. The NMS having received the notification of the band information from the communication apparatus A10 determines the setting information for the port based on the notified band information, and locates the failure due to the mistaken setting and collectively sets the located failures. As a result, the setting information can be checked quickly, and the operation errors such as the mistaken setting on band information can be reduced.

### Third Embodiment

(LT Function, LB Function and CC Function)

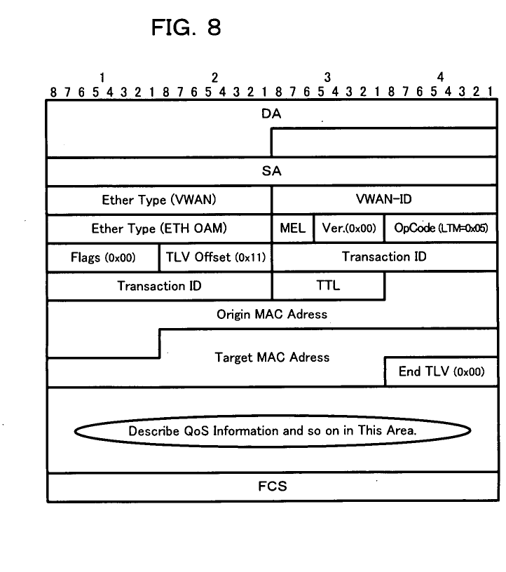

The case has been described in which a continuity test packet is transmitted for checking the connection state of a network according to the first embodiment. According to this embodiment, any one or a plurality of an LT function, LB function and CC function of Ethernet OAM (Operation Administration and Maintenance) is be used to transmit a continuity test packet. More specifically, any one or a plurality of an LT (Link Trace) function having a function of checking path information and locating a failure, an LB (Loop Back) function having a function of transmitting a test frame to check the connection and a CC (Continuity Check) function having a function of exchanging a test frame periodically to check the connection is used to transmit a continuity test packet. In this case, the setting information added to the continuity response packet from the port having received a continuity test packet is added to the part “Describe QoS Information and so on in This Area” as shown in FIG. 8. FIG. 8 is a diagram showing an example of the format of the continuity response packet using the LT function. As a result, the continuity test packet can be transmitted as a part of the standard function.

### Fourth Embodiment

(Holding Expected Value of Setting Information in Hardware)

The case has been described in which the band information notified from the communication apparatus A10 is checked by the management device 1 according to the first embodiment. However, according to this embodiment, the expected value of the setting information for a destination port is held in hardware in advance. More specifically, a storage section is provided in multiple ports for storing an expected value of the band information, and if a continuity response packet is received from a destination port, whether the stored expected value agrees with the band information added to the response packet or not is determined. Then, the determination result is notified to the management device 1. As a result, the response speed can be increased.

### Fifth Embodiment

(Transmission of Continuity Test Packet Including Setting Information of Receiver of Continuity Test Packet)

The case has been described in which the port having received a continuity test packet always responds a continuity response packet to the port having transmitted to the continuity test packet according to the first embodiment. According to this embodiment, a continuity test packet including the setting information of the receiver of a continuity test packet is transmitted. More specifically, each of multiple ports holds the band information of the destination port to which data is transmitted based on a predetermined transmission path. A continuity test packet including the held band information of the destination port is transmitted, and the destination port determines whether the obtained band information agrees with the band information included in the received continuity test packet or not. Only if not, a continuity response packet is generated and is responded to the port having transmitted the continuity test packet. As a result, whether it is the right setting value bidirectionally or not can be checked.

### Sixth Embodiment

(Loss of Transmit Packet in NMS)

According to the second embodiment, a position where the transmit packets of LT and Ping in the NMS have been lost may be notified if a failure occurs due to the loss. As a result, a failure can be located more quickly.

### Seventh Embodiment

(Transmit Continuity Test Packet Periodically)

The case has been described in which the communication apparatus A10 is transmitted in a case where the management device 1 requests continuity check according to the first embodiment. According to this embodiment, a continuity test packet may be transmitted periodically. More specifically, each of multiple ports holds the band information of a destination port to which data is transmitted based on a predetermined transmission path. The held band information is added to a continuity test packet, which is then transmitted based on the transmission path periodically to the port that transfers to the destination. Then, whether the obtained band information agrees with the band information added to the received continuity test packet or not is determined. Only if not, a continuity response packet may be generated and be responded to the port having transmitted the continuity test packet. As a result, the setting information is monitored at all times, and the occurrence of a failure can be addressed more quickly.

### Eighth Embodiment

(Check of Setting Information in Receiver Side)

The case has been described in which the band information notified from the communication apparatus A10 is checked by the management device 1 according to the first embodiment. According to this embodiment, the receiver side of a continuity test packet checks the setting information. More specifically, each of the multiple ports holds the band information of a destination port to which data is transmitted based on a predetermined transmission path. If a continuity check request is received from the management device 1, the held band information is added to a continuity test packet, which is then transmitted based on the transmission path to the port that transfers to a destination. Then, whether the obtained band information agrees with the band information added to the received continuity test packet or not is determined. Only if not, a continuity response packet may be generated and be responded to the port having transmitted the continuity test packet. As a result, the setting information from the transmitter to the receiver can be checked.

### Ninth Embodiment

(Update Setting by NMS)

The case has been described in which the setting information of the port that transfers to a destination is held in advance, and the held setting information is added to a continuity test packet to be transmitted according to the eighth embodiment. According to this embodiment, the setting information of each of the ports is updated by an NMS. More specifically, an NMS that centrally manages a network is used to automatically update setting information if the setting information is changed at the port. As a result, the error detection due to miscommunication regarding the update of setting information can be prevented.

### Tenth Embodiment

(Details of Setting Information)

The case has been described in which band information is stored as the setting information according to the first or second embodiment. According to this embodiment, various kinds of information, which are different from band information, are stored as the setting information. This embodiment is described under “Transmission Rate and Duplex Information”, “Policer Information and Classify Information”, “Shaper Information and CoS Conversion Information”, “LA Information” and “Storage of Setting Information for Each VLAN”.

(Transmission Rate and Duplex Information)

According to the first or second embodiment, for each of the multiple ports, the transmission rate describing a transmission speed of an apparatus connecting thereto over a network and the Duplex information describing a communication method of bidirectional communication are further stored. If a continuity test packet is received by a port that transfers, one or a plurality of the transmission rate and Duplex information set for the port having received the continuity test packet can be further obtained in addition to the band information. As a result, more detail setting information can be checked.

(Policer Information and Classify Information)

According to the first embodiment, Policer information describing the input band and Classify information describing the grouping of data to be input are further stored for the multiple ports. If a continuity test packet from an external port is received by a port that transfers, one or a plurality of the Policer information and Classify information set for the port having received the continuity test packet can be obtained in addition to the band information. As a result, the input side can check more detail information.

(Shaper Information and CoS Conversion Information)

According to the first embodiment, Shaper information describing the output band and CoS conversion information describing the priority of frames are further stored for the multiple ports. In response to the receipt of a continuity test request, data is received based on a predetermined transmission path, and one or a plurality of the Shaper information and CoS conversion information are further obtained in addition to the band information. Then, the obtained setting information is added to a continuity test packet, which is then transmitted from the port having received the continuity test request to the port that transfers to a destination. As a result, the output side can check more detail setting information.

(LA Information)

According to the first embodiment, LA information that virtually handles multiple lines as one line is further stored for the multiple ports. If a continuity test packet is received by a port that transfers, whether the port having received the continuity test packet has the LA information or not is determined, and if so, total set number information can be obtained in addition to the band information. As a result, the total band can be checked in a case where the band is reinforced by LA setting with a different port.

(Storage of Setting Information for Each VLAN)

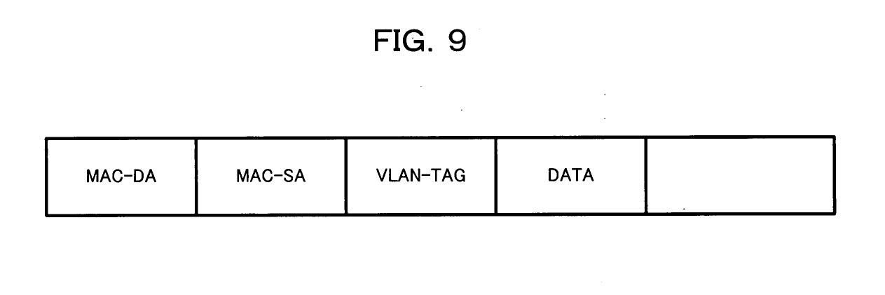

According to the first or second embodiment, the setting information set for each VLAN that defines a virtual group separately from a physical connection form may be further stored. In this case, the setting information to be added to the continuity response packet from the port having received the continuity test packet is added to the part in the “DATA” area as shown in FIG. 9. FIG. 9 is a diagram showing an example of the format of the continuity response packet when a VLAN tag is used. “DATA” area has the setting information that is configuration information. As a result, the setting information can be checked for each VLAN within a port.

### Eleventh Embodiment

Having described the embodiments up to this point, other embodiments may be implemented in various different forms. Different embodiments are described in relation to (1) Configuration of Communication Apparatus and (2) Programs.

(1) Configuration of Communication Apparatus

The processing routines, control routines, specific names, information including data and parameters (such as information stored by the “setting information storage section 12b” shown in FIG. 2) described herein or illustrated in the drawings may be changed arbitrarily unless otherwise indicated.

The components of the shown apparatus are functionally conceptual and are not always required to configure physically as shown in the drawings. That is, the specific forms of distribution and unification of apparatus and devices are not limited to shown ones, but all or a part of them can be functionally or physically distributed or unified in arbitrary units according to the loads or the usage, such as the unification of the setting information obtaining section 13b and the continuity response packet transmitting section 13c as a continuity response packet processing section that obtains setting information and adds the obtained setting information to a continuity response packet and responds it. Furthermore, all or an arbitrary part of processing functions to be implemented in the apparatus and devices may be implemented by a CPU and programs, which are analyzed and executed by the CPU, or may be implemented by hardware with wired logics.

The case of the transmission from the communication apparatus A10 to the communication apparatus B20 based on a predetermined transmission path according to the first or second embodiment has been described. According to this embodiment, the predetermined transmission path may be from the communication apparatus B20 to the communication apparatus A10 or may be from the shown communication apparatus C30 or other multiple communication apparatus connecting thereto.

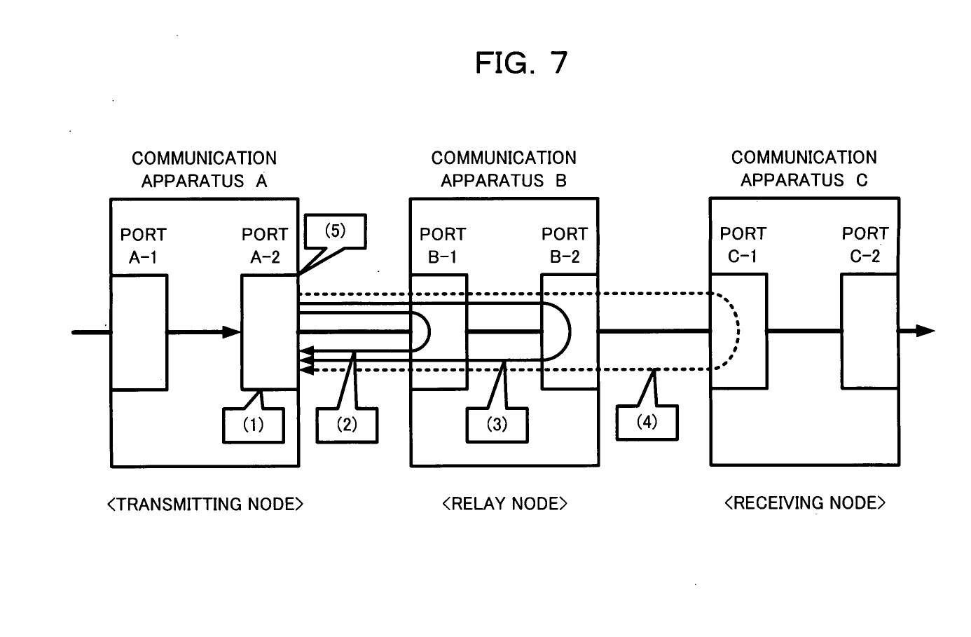

The processing using the communication apparatus A10 only according to the first or second embodiment has been described. According to this embodiment, the processing may be performed by using multiple communication apparatus as shown in FIG. 7.

For example, the communication apparatus A10 transmits a continuity test packet from the “Port A-2” to the “Port C-2” of the communication apparatus C30 (refer to (1) in FIG. 7). Then, the communication apparatus A10 receives a continuity response packet from the “Port B-1” of the communication apparatus B20, a continuity response packet from the “Port B-2” of the communication apparatus B20 and a continuity response packet from the “Port C-1” of the communication apparatus C30 (refer to (2), (3) and (4) in FIG. 7). The continuity response packet from the “Port C-1” of the communication apparatus C may or may not be received by the “Port A-2” of the communication apparatus A since the “Port B-2” of the communication apparatus B has a mistaken band setting (refer to (4) in FIG. 7). After that, the communication apparatus A10 recognizes the mistaken setting based on the continuity response packet from the “Port B-2” of the communication apparatus B20 (refer to (5) in FIG. 7). As a result, the setting information of the position having an influence on the failure of the entire network can be checked. FIG. 7 is a diagram for describing setting information notification processing by multiple communication apparatus.

(2) Programs

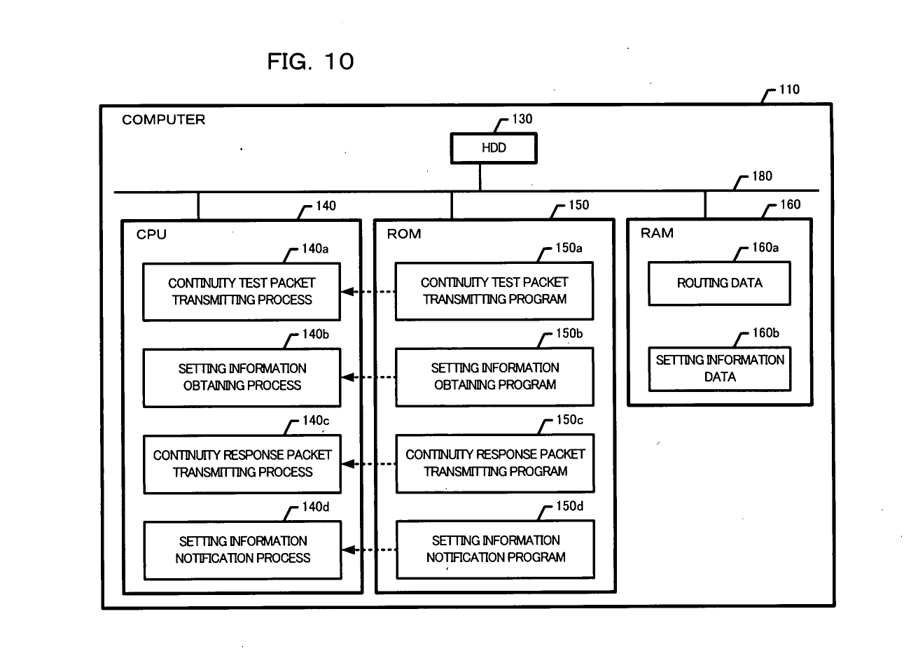

The case has been described in which processing is implemented by hardware logics according to the embodiments above. According to the embodiment, processing may be implemented by executing a prepared program by a computer. With reference to FIG. 10, an example of the computer that executes a communication program having the same function as that of the communication apparatus according to the embodiments above is described. FIG. 10 is a diagram showing a computer that executes a communication program.

As shown in FIG. 10, the computer 110 functioning as a communication apparatus includes an HDD 130, a CPU 140, a ROM 150 and a RAM 160, which are connected via a bus 180, for example.

The ROM 150 prestores communication programs that exhibit the same functions as those of the communication apparatus A10 according to the first embodiment, that is, a continuity test packet transmitting program 150a, a setting information obtaining program 150b, a continuity response packet transmitting program 150c and a setting information notifying program 150d, as shown in FIG. 10. The programs 150a to 150d may be unified or distributed as required like the components of the communication apparatus A10 shown in FIG. 2.

The CPU 140 loads and executes the programs 150a to 150d from the ROM 150 so that the programs 150a to 150d can function as a continuity test packet transmitting process 140a, a setting information obtaining process 140b, a continuity response packet transmitting process 140c and a setting information notifying process 140d. The processes 140a to 140d correspond to the continuity test packet transmitting section 13a, setting information obtaining section 13b, continuity response packet transmitting section 13c and setting information notification section 13d shown in FIG. 2, respectively.

The CPU 140 executes the communication programs based on routing data 160a storing data transmission path information over a network connecting to the communication apparatus A10 and setting information data 160b storing band information set for multiple ports, which are stored in the RAM 160.

The programs 150a to 150d are not always required to store in the ROM 150 from the beginning but may be prestored in a “portable physical medium” such as a flexible disk (or FD), a CD-ROM, a DVD, a magneto-optical disk and IC card, a “fixed physical medium” such as an HDD provided inside or outside of the computer 110, or a “different computer (or server)” connecting to the computer 110 over a public line, the Internet, a LAN or a WAN, for example, from which the computer 110 may load and execute the programs.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus having a plurality of ports for transmitting and receiving data based on a predetermined transmission path to an apparatus connecting thereto over a network, the communication apparatus comprising:
means for adding band information of a port receiving a continuity test signal to a response signal for the continuity test signal for testing a connection state of the network; and
means for notifying the band information added to the response signal to a node for managing the network.

2. A communication apparatus having a plurality of ports for transmitting and receiving data based on a predetermined transmission path to an apparatus connecting thereto over a network, the communication apparatus comprising:
a setting information storage section for storing band information set on each port;
a continuity test signal transmitting section for receiving a continuity test request for testing a connection state of a connected network, and transmitting a continuity test signal to a destination port on the transmission path;
a setting information obtaining section for obtaining the band information set on a port receiving the continuity test signal from the setting information storage section;
a continuity response signal transmitting section for responding a continuity response signal added the band information obtained from the setting information obtaining section to the continuity test signal, to the port having transmitted the continuity test signal; and
a setting information notification section for notifying the band information added to the continuity response signal to a node for managing the network.

3. The communication apparatus according to claim 2,
wherein the continuity test signal transmitting section transmits the continuity test signal to the destination port on the transmission path, by using one or a plurality of an LT (link trace) function having functions for checking path information of Ether OAM (operation administration and maintenance) and locating a failure, an LB (loop back) function having a function for transmitting a test frame to check a connection, and a CC (continuity check) function having a function for transmitting and receiving a test frame periodically to check the connection.

4. The communication apparatus according to claim 2,
wherein the continuity test signal transmitting section transmits the continuity test signal to the destination port on the transmission path, by using an ICMP (Internet control message protocol) having function for transmitting an error massage and a control massage.

5. The communication apparatus according to claim 2, further comprising;
an expected value storage section for storing an expected value of the band information for the plurality of ports,
wherein the setting information notification section compares the band information added to the continuity response signal with the expected value stored in the expected value storage section, and notifies the comparison result to the node for managing the network.

6. The communication apparatus according to claim 2, further comprising;
a band information maintenance section for holding the band information of the destination port transmitted data based on the transmission path, on each port,
wherein the continuity test signal transmitting section adds the band information held on the band information maintenance section to the received continuity test request, and transmits the continuity test signal added the band information to the destination port on the transmission path,
the setting information obtaining section obtains the band information set on the port that receives the continuity test signal added the band information, and
the continuity response signal transmitting section determines whether the band information obtained by the setting information obtaining section agrees with the band information added to the received continuity test signal or not and, in only case of not agreeing, generates a continuity response signal added the band information obtained from the setting information obtaining section, to the continuity test signal, and responds the generated continuity response signal to the port having transmitted the continuity test signal.

7. The communication apparatus according to claim 2, further comprising;
a band information maintenance section for holding the band information of the destination port transmitted data based on the transmission path, on each port,
wherein the continuity test signal transmitting section adds the band information held on the band information maintenance section to the received continuity test request, and periodically transmits the continuity test signal added the band information to the destination port on the transmission path from each port,
the setting information obtaining section obtains the band information set on the port that receives the continuity test signal added the band information, and
the continuity response signal transmitting section determines whether the band information obtained by the setting information obtaining section agrees with the band information added to the received continuity test signal or not and, in only case of not agreeing, generates a continuity response signal added the band information obtained from the setting information obtaining section, to the continuity test signal, and responds the generated continuity response signal to the port having transmitted the continuity test signal.

8. The communication apparatus according to claim 2,
wherein the setting information storage section further stores transmission rate information describing the speed of transmission by the multiple ports to an apparatus connecting thereto over a network and Duplex information describing a communication method for bidirectional communication, and
the setting information obtaining section further obtains one or a plurality of the transmission rate information and the Duplex information set for the port having received the continuity test signal, in addition to the band information from the setting information storage section.

9. The communication apparatus according to claim 2,
wherein the setting information storage section further stores Policer information describing an input band for each port and classify information describing a grouping of the input data, and
the setting information obtaining section further obtains one or a plurality of the Policer information and the classify information set for the port having received the continuity test signal, in addition to the band information from the setting information storage section.

10. The communication apparatus according to claim 2,
wherein the setting information storage section further stores Shaper information describing an output band for each port and CoS conversion information describing a priority of frames, and
the continuity test signal transmitting section receives the continuity test request based on the transmission path, and transmits a continuity test signal added one or a plurality of the Shaper information and the CoS conversion information to the band information obtained together from the setting information storage section, to the destination port on the transmission path.

11. The communication apparatus according to claim 2,
wherein the setting information storage section further stores LA information that virtually handles a plurality of lines as one for the plurality of ports, and
the setting information obtaining section determines whether the port having received the continuity test signal has the LA information or not and, in case of having the LA information, further obtains total-set-number information in addition to the band information from the setting information storage section.

12. The communication apparatus according to claim 2,
wherein the setting information storage section further stores setting information set for a VLAN that sets a virtual group separately from a physical connection form.

13. A communication apparatus having a plurality of ports for transmitting and receiving data based on a predetermined transmission path to an apparatus connecting thereto over a network, and the communication apparatus being connected to an NMS (network management system) for grasping setting information on the plurality of ports and managing collectively the network, the communication apparatus comprising:
a setting information storage section for storing band information set on each port;
a continuity test signal transmitting section for receiving a continuity test request for testing a connection state of a connected network, and transmitting a continuity test signal to a destination port on the transmission path, in case of generating an event over the network;
a setting information obtaining section for obtaining the band information set on a port receiving the continuity test signal from the setting information storage section;
a continuity response signal transmitting section for responding a continuity response signal added the band information obtained from the setting information obtaining section to the continuity test signal, to the port having transmitted the continuity test signal; and
a setting information notification section for notifying the band information added to the continuity response signal to the NMS.

14. The communication apparatus according to claim 13,
wherein the continuity test signal transmitting section transmits the continuity test signal to the destination port on the transmission path, in case of generating one of a trap having a function for notifying an event occurrence over the network and a syslog having a function of displaying or recording an event and information in a message occurring in the system.

15. A communication method for a communication apparatus having a plurality of ports for transmitting and receiving data based on a predetermined transmission path to an apparatus connecting thereto over a network, the communication method comprising:
a setting information storage step of storing band information set on the plurality of ports;
a continuity test signal transmitting step of receiving a continuity test request signal for testing a connection state of a connected network, and transmitting a continuity test signal to a destination port on the transmission path;
a setting information obtaining step of obtaining the band information set on a port receiving the continuity test signal from the setting information storage step;
a continuity response signal transmitting step of responding a continuity response signal added the band information obtained from the setting information obtaining step to the continuity test signal, to the port having transmitted the continuity test signal; and
a setting information notification step of notifying the band information added to the continuity response signal to a node for managing the network.
